(19) United States
(12) Patent Application Publication
(10) Pub. No.: US 2004/0258937 A1
(43) Pub. Date: Dec. 23, 2004

(54) Adhesive

(76) Inventors: Dirk Achten, Koln (DE); Martin Hoch, Heinsberg (DE); Martin Mezger, Burscheid (DE); Rudiger Musch, Bergisch Gladbach (DE); Hans-Rafael Winkelbach, Burscheid (DE); Roland Parg, Leverkusen (DE)

Correspondence Address: BAYER MATERIAL SCIENCE LLC, 100 BAYER ROAD, PITTSBURGH, PA, 15205, US

(21) Appl. No.: 10/866,888

(22) Filed: Jun. 14, 2004

(30) Foreign Application Priority Data
Jun. 18, 2003 (DE) 10327452.9

(51) Int. Cl. C08F 8/00; B32B 27/00

(52) U.S. Cl. 428/500; 156/331.2; 156/330.9; 525/119; 525/123; 525/154; 525/332.4; 525/329.1

(57) ABSTRACT

The invention relates to an adhesive based on highly saturated, carboxylated nitrile-butadiene rubber (HXNBR), to its use, to processes for its preparation, to its use for the bonding of substrates and to products manufactured therewith.

### CROSS REFERENCE TO RELATED PATENT APPLICATION

The present patent application claims the right of priority under 35 U.S.C. §119 (a)-(d) of German Patent Application No.103 27 452.9, filed Jun. 18, 2003.

### FIELD OF TH INVENTION

The present invention relates to novel adhesives containing a highly saturated, carboxylated nitrile-butadiene rubber (HXNBR) together with other fillers and additives, to their preparation, to their use, especially for bonding metal, rubber, plastics, glass, leather, wood and other materials, and to the product manufactured from the different materials by bonding with the composition.

### BACKGROUND OF THE INVENTION

There is a great need for compositions that can be used for bonding different materials without having to subject the surfaces of the materials used to a special pretreatment. Typically, for the systems currently available on the market, the surface of the substrate has to undergo expensive cleaning and/or priming in order to achieve an acceptable bonding strength. This applies particularly to the bonding of rubber substrates to metal or of metal to metal. In this precise field of use, good adhesion is only achieved if the adhesive raw materials used are halogenated compounds based on natural rubber or synthetic rubbers, e.g. those described in EP-A 0 545 593, halogenated polymers based on EPDM, e.g. those described in EP-A 0 427 954, or other halogenated polymers such as chlorinated styrene-olefin block copolymers grafted with acrylates, as described in JP-A 4 175 308. Such halogen-containing products are to be regarded critically for toxicological and ecological reasons.

The rubber/metal bonding agents currently available on the market are used for the bonding of different elastomers, for example natural, styrene-butadiene, chloroprene, acrylonitrile-butadiene, isoprene-butadiene, butyl, ethylene-propylene, epichlorohydrin, chlorosulfonylethylene, urethane-silicone, acrylate and fluorinated rubbers, to metals, for example iron, steel, aluminium, brass, etc., or to many plastics, such as polyamides, polyepoxides, polyoxymethylenes and polyfluoroethylenes, as well as to glass and woven fabric, for the manufacture of a wide variety of products. They are used primarily for the production of all kinds of vibration absorbing elements such as engine mountings, coupling elements, various bearings, various gaskets, rolls, rollers, rail elements and bridge elements.

Conventionally, a rubber mixture is prepared first and the metals to be bonded with the rubber mixture are subjected to a pretreatment, followed by coating of the metal parts with bonding agents or with primer and bonding agent.

The metal parts are degreased, e.g. in chlorohydrocarbon vapour (perchloro-ethylene, trichloroethane or 1,1,1-trichloroethane) or acetone, and then blasted with chilled cast iron shot or corundum. The blasting material used is chilled cast iron shot for steel surfaces and corundum for other, non-ferrous metals such as aluminium or brass. The chemical pretreatment of metal is complicated because different processes have to be used for different metals. Thus, for example, aluminium sheets are chemically cleaned either with an alkaline, silicate-free degreasing agent based on phosphate-borate, or with scouring greases containing phosphoric acid, or by the pickling process (DIN 53281, Part 1) in order to be ready for bonding. These processes create substantial problems as regards proper disposal of the pickling baths.

Simple cleaning, with possible blasting if needed, is usually sufficient for the pretreatment of plastic surfaces. In the case of polyoxymethylene and polyfluoro-ethylene, the surfaces have to be chemically pretreated. It should be pointed out that metal surfaces are not stored for long after blasting because bonding can be impaired by the oxide layer formed. For this reason, metal parts should be coated with primer as quickly as possible after blasting.

There is therefore an urgent need for adhesives which adhere well, even to non-pretreated substrates, and which are halogen-free in order to comply with the increased ecological demands of the market.

WO 01177185 describes in general terms the good adhesion of HXNBR to fibres, metal, glass, wood, wool, silk, synthetic fibres and polymers, as well as polar plastic materials. The good adhesive capacity, even at high temperatures, is mentioned as an outstanding property. Drive belts and control belts are mentioned as particular applications. Application as an adhesive for the bonding of two substrates which may be different, and the formulations required for this purpose, are not disclosed.

EP-A 1 083 197 describes mixtures of HXNBR with metal acrylates and liquid acrylates, carbon blacks and/or silica, and with sulfur-based and peroxide-based rubber crosslinking systems commonly used in the rubber industry, for use as coating mixtures and adhesive mixtures, e.g. for paper rollers, with excellent adhesion to the metal surfaces of the roller cores. Again, this is not an application of adhesive for the bonding of two substrates which may be different.

The use of metal auxiliary agents, such as zinc diacrylate, for improving the adhesion of rubber materials to metals is known (Rubber World, November 1998, pages 18-30). The possibility of these mixtures also adhering to oil-coated metal surfaces is described. The use of these systems in connection with carboxylated rubbers, especially HXNBR, as bonding and/or adhesive systems is not described.

WO 00/43131 describes adhesives with elastomers as components for the bonding of metal and rubber mixtures. Carboxylated acrylonitrile-butadiene rubbers, inter alia, are listed, but HXNBR is not mentioned.

The object of the present invention is therefore to provide a composition which exhibits outstanding adhesion and cohesion on untreated surfaces without a primer, so that it can be used as an adhesive.

### SUMMARY OF THE INVENTION

The present invention is directed to an adhesive that includes 0.1 to 98 wt. % of carboxylated nitrile-butadiene rubber (HXNBR).

The present invention is also directed to a method of bonding two or more materials or substrates including applying the above-described adhesive to a surface of at least one of the materials or substrates, the metal and/or the substrates and then contacting the surfaces of the metal and the substrates. The materials or substrates being selected from metal, glass, rubber, thermoplastic, wood, ceramic, leather, stone, concrete, plastic, fibres and textile fabrics made of natural, synthetic, glass/mineral and metal fibres.

The present invention is further directed to composite products that include two or more materials joined with the above described.

The present invention is additionally directed to a process for preparing the above-described adhesive, including mixing the constituents of the formulation in conventional mixers.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

Surprisingly, it has been found that the use of halogen-free, highly saturated, carboxylated nitrile-butadiene rubber (HXNBR) as an elastomer component in adhesive formulations results in excellent adhesion, even on non-pretreated substrates.

The object of the invention is therefore achieved by a composition containing 0.1 to 98 wt. % and preferably 0.5 to 95 wt. % of HXNBR and 2 to 99.9 wt. % and preferably 5 to 99.5 wt. % of additives, optionally fillers and/or solvents, it being necessary for the additives to include at least one additive capable of crosslinking. Said composition can advantageously be used as an adhesive.

Additives capable of crosslinking are selected from the group comprising peroxides, redox systems, epoxides, sulfur compounds, polyvalent ions, amines, formaldehyde resins and isocyanates, all of these additives being capable of effecting the requisite reactive curing of the adhesive materials.

The adhesives according to the invention can contain up to 80 wt. % of metal acrylates and/or methacrylates as other additives or fillers.

The adhesives according to the invention can contain up to 20 wt. % of polyvalent metal ions in the form of organic salts, e.g. aluminium stearate, as other additives or fillers. Depending on the substrates to be joined, the presence of such additives is advantageous because polyvalent metal ions increase the yield strength of the adhesive applied and the adhesion towards metal and polarizable substrates and substrates capable of undergoing ionic interactions, for example polyamides, polyurethanes and polycarbonates. The choice of suitable additives and fillers is conventionally made by those skilled in the art on the basis of preliminary experiments with the substrates to be joined. Further instructions and suggestions regarding the arrangement of such experiments can be found in the Examples below.

The HXNBR used according to the invention is preferably a highly saturated HXNBR with a nitrile group content (calculated as acrylonitrile (ACN)) preferably of 10 to 60 wt. %, a residual double bond content of 0 to 20% and a carboxyl group content of 1 to 20 wt. % of COOH groups, calculated as corresponding monomeric carboxylic acid, said COOH groups being present in the form of copolymerizable acids containing carboxylic acid groups randomly distributed in the polymer backbone, it being possible for some or all of these carboxyl groups to be present in the form of metal salts.

The adhesives according to the invention are advantageously used in the form of a paste, a film, a thin layer, an aqueous dispersion or a dispersion or solution in organic solvents.

An adhesive according to the invention is advantageously used for the bonding of metal or rubber to metal, glass, rubber, thermoplastic, wood, ceramic, leather, stone, concrete, plastic, fibres, textile fabrics made of natural, synthetic, glass/mineral and metal fibres, and all possible combinations of these materials with one another.

The invention also provides products constructed from two or more materials which have been joined with adhesives according to the invention. Examples of such products are engine beds and Silentbloc-type rubber-metal connections, shaft couplings, Hardy discs, drive belts, pneumatic tyres, cables, rolls and reinforced seals.

As used herein, the term “composite” refers to a material made up of more than one substance, wherein one of the substances is the adhesive of the present invention. A non-limiting example being a composite that includes the present adhesive and one or more substrates as identified herein, a non-limiting example being products constructed from two or more materials as described above.

Adhesive compositions according to the invention preferably contain 0.5 to 95 wt. % of carboxylated nitrile-butadiene rubber (HXNBR). Nitrile group is preferably understood as meaning repeat units derived from acrylonitrile, methacrylonitrile and α-chloroacrylonitrile. Repeat units derived from acrylonitrile are particularly preferred.

The copolymerizable acids containing carboxylic acid groups which are used to make up the carboxylated part of the hydrogenated carboxylated nitrile-butadiene rubber are α,β-unsaturated acids. It is preferable to use acrylic acid, methacrylic acid, ethylacrylic acid, crotonic acid, maleic acid, maleic anhydride, fumaric acid and/or itaconic acid. Acrylic acid and methacrylic acid are very particularly preferred.

It is also possible for some or all of the carboxyl groups to be present in the form of metal salts —COOMe, where Me is a metal ion. Preferably up to 60% and particularly preferably 5 to 25% of the carboxyl groups are present in the form of metal salts. The metal ions which can be used are all monovalent, divalent, trivalent and tetravalent metals of the Periodic Table, preference being given to alkali metals and alkaline earth metals as well as Ti, Fe, Ni, Co, Cu, Zn, Sn, Al and Si.

Particularly preferably, the highly saturated HXNBR contained in the adhesives according to the invention has a nitrile group content (calculated as acrylonitrile) of 18 to 43 wt. % and a residual double bond content of 0.1 to 5%.

The butadiene groups of the HXNBR are repeat units derived from 1,3-butadiene which is extensively in hydrogenated form.

The hydrogenation of the carboxylated nitrile-butadiene rubber is carried out with a catalyst/cocatalyst system described in WO 01/77185 (page 5, line 13 to page 6, line 28) and under the reaction conditions described therein (page 6, line 29 to page 7, line 22).

An adhesive composition according to the invention can contain 2 to 98 wt. %, preferably 5 to 95 wt. % and particularly preferably 20 to 85 wt. % of other fillers, additives and additional polymers. Other fillers and additives are understood as meaning carbon blacks, silicates, clays, chalk, heat stabilizers and ageing stabilizers, crosslinking agents, auxiliary agents, plasticizers and process oils, i.e. in general terms other formulating components commonly used in the rubber and plastics industry. Additional polymers which may be mentioned are any compounds obtainable via free-radical and/or ionic polymerization as well as polycondensation or polyaddition, e.g. polychloroprene, polyisobutylene, polyvinyl acetate, polypropylene, polyurethanes, polyamides, polyepoxy resins, formaldehyde resins and any compounds obtainable from these by polymer-analogous reactions such as grafting. Precursors which are converted to polymers during the activation of the adhesive may also be mentioned.

In addition to the polymers, fillers and additives already mentioned, the adhesive composition can contain preferably 5 to 80 wt. % and particularly preferably 10 to 50 wt. % of other metal acrylates and/or methacrylates. Preferred metal (meth)acrylates are zinc diacrylate and zinc dimethacrylate.

An adhesive composition according to the invention contains preferably up to 20 wt. % and particularly preferably 0.1 to 10 wt. % of other polyvalent metal ions in the form of inorganic salts, oxides or organic salts, e.g. aluminium acetate, aluminium stearate, aluminium tri(meth)acrylate, zinc oxide, titanium tetrachloride, titanium tetraalcoholate, titanium tetrastearate and magnesium sulfate.

The adhesives according to the invention are prepared by mixing the constituents in conventional mixers, such as mixing mills or rubber masticators, and/or in solution/dispersion/suspension/emulsion.

The use according to the invention of the composition as an adhesive makes it possible to bond a wide variety of materials. Thus substrates of similar polarity or non-polar substrates can be bonded together and polar substrates can be combined with otherwise incompatible non-polar substrates. Polar substrates which can be bonded with the composition include e.g. wood, glass, polyamide, polyurethane, polycarbonate and leather. Examples of non-polar substrates which can be bonded with the composition are metals.

Adhesives according to the invention are also obtained by adding HXNBR to bonding systems of the state of the art in such a way as to observe the amounts given above for adhesives according to the invention.

The adhesives according to the invention are superior to bonding systems of the state of the art. The following list shows examples of various applications of the adhesives according to the invention without implying a limitation:

By adding HXNBR to existing solvent-based and/or hot-setting adhesive systems, for example of the Dispercoll®, Desmodur®, Desmomelt® and Levamelt® types (Bayer AG) based on polychloroprene, polyisocyanates, polyurethanes and polyvinyl acetate, and e.g. the adhesive systems based on Chemosil® (Henkel KGaA), adhesive formulations according to the invention are obtained whose adhesion to “reactive” substrates (e.g. leather, wood, polyamide, polyester, polycarbonate, etc.) is markedly better than that of systems of the state of the art.

The adhesives according to the invention have a high affinity for glass and glass fibres. Their use for joining glass-metal, glass-glass and glass-rubber affords high strengths over a wide temperature range.

Adhesives according to the invention which contain epoxy resins and metal acrylates exhibit extreme shear strengths, even at high temperatures. Adhesive bonds obtained in this way are still stable and functional at temperatures of approx. −20° C. The bonds exhibit an excellent resistance to oxygen and chemicals.

Adhesives according to the invention are also capable of bonding oil-soiled non-pretreated substrates directly without the devastating losses of adhesive properties known for conventional adhesive systems.

The crosslinking temperature of the adhesives according to the invention can be adjusted over a wide temperature range, as is known in the case of epoxy, elastomeric and acrylic systems. Furthermore, adhesion and strength can be adjusted within wide limits via the additional use of polyvalent metal ions.

The adhesives according to the invention exhibit even more advantages: They are suitable for the bonding of a large number of different substrates without their bonding surfaces having to be cleaned or undergo any other pretreatment known to those skilled in the art. A further advantage is the broad spectrum of use of the adhesives according to the invention, it being possible to bond a very wide variety of polar or non-polar materials together. Selected adhesives according to the invention are chemically resistant both to ozone and to other substances and are harmless to health. The adhesives according to the invention can be used continuously up to temperatures of 150° C.

### EXAMPLES

A. Substances Used

TABLE 1

| | |
|---|---|
| Therban ® C3467 | (Bayer AG) hydrogenated acrylonitrile-butadiene |
| | copolymer (HNBR) |
| Therban ® VPKA 8796 | (Bayer AG) hydrogenated acrylonitrile-butadiene |
| | copolymer (HNBR), 50% as masterbatch with zinc |
| | diacrylate |
| Therban ® C3457 | (Bayer AG) hydrogenated acrylonitrile-butadiene |
| | copolymer (HNBR) |
| Therban ® VPKA 8889 | (Bayer AG) hydrogenated acrylonitrile-butadiene |
| | copolymer (HNBR) |
| Vulkasil ® A1 | (Bayer) semiactive precipitated NaAl silicates, pH = 10-12 |
| Rhenofit ® DDA-70 | (Rhein Chemie GmbH) (70% diphenylamine |
| | derivative (dry liquid)) |
| Vulkanox ® ZMB2/C5 | (Bayer AG) (Zn methylmercaptobenzimidazole) |
| Polydispersion T D-40P VC | (Rhein Chemie GmbH) di(tert-butylperoxyisopropyl) |
| | benzene, 40% polymer dispersion |
| Struktol ® ZP 1014 | (Schill + Seilacher) zinc peroxide, approx. 55% |
| | dust-free zinc peroxide with added dispersant, |
| | accelerator for XNBR and HNBR vulcanisation |
| Sartomer Saret ® S633 | (Cray) metal diacrylate with added retarder |
| Tefacid ® RG | (Tefac) stearic acid |
| Vulkacit ® CZ/EG | (Bayer AG) cyclohexylbenzothiazolesulfenamide |
| | (CBS) in granular form |
| Vulkacit ® Thiuram/C | (Bayer AG) tetramethylthiuram disulfide (TMTD), |
| | coated |
| Rhenocure ® M | (Rhein Chemie GmbH) dithiodimorpholine |
| | (DTDM), polymer-bound |
| Struktol ® SU 95 | (Schill + Seilacher) 95% soluble sulfur + organic |
| | processing aid |
| Corax ® N550 | (Degussa AG) carbon black, FEF (Fast Extrusion |
| | Furnace) |
| Cohedur ® RL | (Bayer AG) 45.5% resorcinol, 45.5% Cohedur ® A |
| | 100, 9% dibutyl phthalate (precondensed resorcinol- |
| | formaldehyde resin) |
| Perkadox ® 14-40 B-GR | (Akzo Nobel AG) di(tert-butylperoxyisopropyl)- |
| | benzene, granulated |
| Aluminium stearate | (Riedel de Haen AG) |

Substrates to be Bonded:

sand-blasted steel plates (60×25×2 mm) made of tool steel (X 12 CrNi 18 8)

polished steel pallets (contact area 12 mm in diameter) made of tool steel (X 12 CrNi 18 8; material number 1.4300)

Makrolon® 2205 (Bayer AG) polycarbonate

Pocan® 1505 (Bayer AG) polyethylene/butylene terephthalate

The following Test Oils were Used:

Pfinder oil from Mobil (PFINDER P 160, special quench oil)

Divinol oil from ZELLER+GMELIN GmbH (engine oil, DIVINOL Multimax HDC3 15W40)

Platinol oil from Oest (OEST PLATINOL B 804/3 C, deep-drawing oil)

B. Method of Measurement

Determination of the Shear Strength:

Thin layers of the mixtures are drawn out on the roller (thickness approx. 1 mm), applied between 2 steel sheets (overlap 12 mm) and vulcanized under 5 bar for different times at different temperatures. The sheets were first degreased with acetone or dipped in various oils.

The adhesive strength was measured by means of the frontal separating device of a Zwick 1475 tester (universal testing machine, standard tester in adhesives technology) with a draw-off speed of 100 mm/min at various temperatures. The strength is given in N/mm².

### C. EXAMPLES

TABLE 1
Adhesive formulations

| | Formulation | | | | | | |
|---|---|---|---|---|---|---|---|
| | A | B | C | D | E | F* | G* |
| Component | Fraction of formulation | | | | | | |
| Therban ® C3467 | | | | | | 100 | |
| Therban ® VPKA | | | | | | | 100 |
| 8796 | | | | | | | |
| Therban ® VPKA | 100 | 100 | 100 | 100 | 100 | | |
| 8889 | | | | | | | |
| Vulkasil ® A1 | 30 | 30 | 30 | | | | 30 |
| Rhenofit ® DDA-70 | 1.4 | 1.4 | 1.4 | | | | 1.4 |
| Vulkanox ® | 0.4 | 0.4 | 0.4 | | | | 0.4 |
| ZMB2/C5 | | | | | | | |
| Polydispersion | 6 | 6 | | | | | 6 |
| T D-40P VC | | | | | | | |
| Zinc peroxide | 6 | 6 | | | | | 6 |
| approx. 55% ZnO₂ | | | | | | | |
| Sartomer Saret ® | | 20 | | | | | 20 |
| S633 | | | | | | | |
| Stearic acid | | | 1 | | | | |
| Vulkacit ® CZ/EG | | | 1 | | | | |
| Vulkacit ® Thiuram/C | | | 1.5 | | | | |
| Rhenocure ® M | | | 1 | | | | |
| Flour sulfur | | | 0.5 | | | | |
| 90/95° Chancel | | | | | | | |
| Aluminium stearate | | | | 4 | 8 | 4 | |

Comparative mixtures not according to the invention are denoted by *.

TABLE 2
Shear strength on steel sheet when using mixture D
according to the invention, with and without contamination
of the sheet surface with oil (strength values given at RT)

| | | |
|---|---|---|
| Experiment | Sheet coating | Adhesive strength [N/mm²] |

Heating time 30 min/130° C.

| | | |
|---|---|---|
| 1 | — | 4.9 |
| 2 | Pfinder oil | 1.2 |
| 3 | Divinol oil | 1 |
| 4 | Platinol oil | 0.4 |

Heating time 10 min/160° C.

| | | |
|---|---|---|
| 5 | — | 4.8 |
| 6 | Pfinder oil | 0.3 |
| 7 | Divinol oil | 1.4 |
| 8 | Platinol oil | 2.3 |

Heating time 5 min/180° C.

| | | |
|---|---|---|
| 9 | — | 3.6 |
| 10 | Pfinder oil | 1.2 |
| 11 | Divinol oil | 2.1 |
| 12 | Platinol oil | 0.1 |

TABLE 3
Shear strength on steel sheet when using mixture E according
to the invention, with and without contamination of the sheet
surface with oil (strength values given at RT)

| | | |
|---|---|---|
| Experiment | Sheet coating | Adhesive strength [N/mm²] |

Heating time 30 min/130° C.

| | | |
|---|---|---|
| 13 | — | 4.6 |
| 14 | Pfinder oil | 1.7 |
| 15 | Divinol oil | 1.9 |
| 16 | Platinol oil | 1.9 |

Heating time 10 min/160° C.

| | | |
|---|---|---|
| 17 | — | 4 |
| 18 | Pfinder oil | 2.4 |
| 19 | Divinol oil | 1.6 |
| 20 | Platinol oil | 2.5 |

Heating time 5 min/180° C.

| | | |
|---|---|---|
| 21 | — | 4.2 |
| 22 | Pfinder oil | 1.4 |
| 23 | Divinol oil | 1 |
| 24 | Platinol oil | 0.1 |

TABLE 4
Shear strength on steel sheet when using comparative
mixture F*, with and without contamination of the sheet
surface with oil (strength values given at RT)

| | | |
|---|---|---|
| Experiment | Sheet coating | Adhesive strength [N/mm²] |

Heating time 30 min/130° C.

| | | |
|---|---|---|
| 25* | — | 0.2 |
| 26* | Pfinder oil | 0.1 |
| 27* | Divinol oil | 0.1 |
| 28* | Platinol oil | 0.1 |

Heating time 10 min/160° C.

| | | |
|---|---|---|
| 29* | — | 0.1 |
| 30* | Pfinder oil | 0.1 |
| 31* | Divinol oil | 0.1 |
| 32* | Platinol oil | 0.1 |

Heating time 5 min/180° C.

| | | |
|---|---|---|
| 33* | — | 0.1 |
| 34* | Pfinder oil | 0.1 |
| 35* | Divinol oil | 0.1 |
| 36* | Platinol oil | 0.1 |

The adhesion to oil-coated non-pretreated sheets (Table 4) of formulations D and E according to the invention based on HXNBR (Tables 2 and 3) is markedly greater than that of comparative mixture F based on HNBR.

TABLE 5
Shear strength on steel sheet when using mixtures A, B and C
according to the invention, with and without contamination of
the sheet surface with oil (strength values given at RT)

| | | |
|---|---|---|
| Experiment | Sheet coating | Adhesive strength [N/mm²] |

Mixture A:
Heating time 15 min/160° C.

| | | |
|---|---|---|
| 37 | — | 10.5 |
| 38 | Pfinder oil | 8.4 |
| 39 | Divinol oil | 8.4 |
| 40 | Platinol oil | 7.2 |

Mixture B:
Heating time 15 min/160° C.

| | | |
|---|---|---|
| 41 | — | 33.2 |
| 42 | Pfinder oil | 21.6 |
| 43 | Divinol oil | 23.1 |
| 44 | Platinol oil | 23.9 |

Mixture C:
Heating time 15 min/160° C.

| | | |
|---|---|---|
| 45 | — | 7.3 |
| 46 | Pfinder oil | 2.1 |
| 47 | Divinol oil | 3.3 |
| 48 | Platinol oil | 3.5 |

TABLE 6
Shear strength on steel sheet when using mixture
B according to the invention, with and without
contamination of the sheet surface with oil (strength
values given at different measurement temperatures)

| | | Adhesive strength | Test temperature |
|---|---|---|---|
| Experiment | Sheet coating | [N/mm²] | [° C.] |
| 49 | — | 35.5 | 23 |
| 50 | Divinol oil | 24.5 | 23 |
| 51 | — | 24.6 | 50 |
| 52 | Divinol oil | 24.2 | 50 |
| 53 | — | 23.2 | 100 |
| 54 | Divinol oil | 18.3 | 100 |

TABLE 7
Shear strength on steel sheet when using comparative
mixture G, with and without contamination of the sheet
surface with oil (strength values given at different
measurement temperatures)

| | | Adhesive strength | Test temperature |
|---|---|---|---|
| Experiment | Sheet coating | [N/mm²] | [° C.] |
| 55* | — | 17.7 | 23 |
| 56* | Pfinder oil | 16.1 | 23 |
| 57* | Divinol oil | 16.5 | 23 |
| 58* | Platinol oil | 13.8 | 23 |
| 59* | — | 16.1 | 50 |
| 60* | Divinol oil | 17.4 | 50 |
| 61* | — | 9.1 | 100 |
| 62* | Divinol oil | 13.5 | 100 |

The adhesion to oil-coated non-pretreated sheets, even at higher test temperatures (Table 7), of formulation B according to the invention based on HXNBR (Table 6) is markedly greater than that of comparative mixture G based on HNBR.

TABLE 8
Different formulations for use as adhesive systems

Formulation

| | | |
|---|---|---|
| H | J | K* |

| | |
|---|---|
| Component | Fraction of formulation |

| | | | |
|---|---|---|---|
| Therban ® VPKA KA 8889 | 100 | 100 | |
| Therban ® C3467 | | | 100 |
| Rhenofit ® DDA-70 | 2 | 2 | 2 |
| Corax ® N 550 | 30 | 30 | 30 |
| Cohedur ® RL | 15 | 15 | 15 |
| Struktol ® ZP 1014 | 6 | 6 | |
| Aluminium stearate | | 4 | |
| Stearic acid | | 1.5 | |
| Perkadox ® 14-40 B-GR | | | 4 |

Formulations D, H and J and comparative mixtures F* and K* were applied as a thin layer between pallet and metal sheet substrate and a pressure of 5 bar was applied to the steel plates at 180° C. for 20 min. The sheet was first degreased with THF.

Formulations D, H, J, F* and K* (Pocan) and D, J and F* (Makrolon) were applied to the other substrates (Pocan, Makrolon) with the aid of a 10% solution/dispersion in THF, between pallet and substrate, and tempered under a slight pressure of approx. 1 bar at 140° C. for 30 min to drive off the solvent.

The adhesive strength was measured by means of the frontal separating device of a Zwick 1445 tester with a draw-off speed of 1 mm/min. The strength is given in N/mm².

The adhesive strength was determined at different temperatures, as shown.

TABLE 9
Adhesive strength on different substrates when using
mixtures D, H and J according to the invention and
comparative mixtures F and K (strength values given at
different measurement temperatures). Method of
measurement: the adhesive strength of metal pallets
(VA2 steel, polished) on different substrates was measured
using the formulations shown at various temperatures.

| | | | |
|---|---|---|---|
| | | Adhesive strength | Measurement |
| Experiment | Material | [N/mm²] | temperature [° C.] |

Formulation: D

| | | | |
|---|---|---|---|
| 63 | Steel | 1.06 | 23 |
| 64 | Steel | 0.98 | 80 |
| 65 | Steel | 0.22 | 100 |
| 66 | Makrolon ® | 1.52 | 23 |
| 67 | Pocan ® | 0.63 | 23 |

Formulation: F*

| | | | |
|---|---|---|---|
| 68* | Steel | 0.62 | 23 |
| 69* | Steel | 0.21 | 80 |
| 70* | Steel | 0.1 | 100 |
| 71* | Makrolon ® | 0.2 | 23 |
| 72* | Pocan ® | 0.1 | 23 |

Formulation: H

| | | | |
|---|---|---|---|
| 73 | Steel | 2.46 | 23 |
| 74 | Steel | 2.05 | 80 |
| 75 | Steel | 1.89 | 100 |
| 76 | Pocan ® | 1.05 | 23 |

Formulation: J

| | | | |
|---|---|---|---|
| 77 | Steel | 2.11 | 23 |
| 78 | Steel | 2.56 | 80 |
| 79 | Steel | 1.08 | 100 |
| 80 | Makrolon ® | 2.04 | 23 |
| 81 | Pocan ® | 0.85 | 23 |

Formulation: K*

| | | | |
|---|---|---|---|
| 82* | Steel | 1.65 | 23 |
| 83* | Steel | 1.40 | 80 |
| 84* | Steel | 1.18 | 100 |
| 85* | Pocan ® | 0.44 | 23 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An adhesive comprising 0.1 to 98 wt. % of carboxylated nitrile-butadiene rubber (HXNBR).

2. The adhesive according to claim 1, wherein the HXNBR is a highly saturated HXNBR with a nitrile group content, calculated as acrylonitrile, of from 10 to 60 wt. %.

3. The adhesive according to claim 1, wherein the HXNBR has a residual double bond content of 0 to 20%.

4. The adhesive according to claim 1, wherein the HXNBR has a carboxyl group content of 1 to 20 wt. %, calculated as corresponding monomeric carboxylic acid, said carboxyl groups being present in the form of copolymerizable acids containing carboxylic acid groups randomly distributed in the polymer backbone.

5. The adhesive according to claim 4, wherein some or all of the carboxyl groups are present in the form of metal salts.

6. The adhesive according to claim 1 comprising up to 80 wt. % of metal acrylates and/or methacrylates.

7. The adhesive according to claim 1 comprising up to 30 wt. % of a component that forms a formaldehyde resin.

8. The adhesive according to claim 1 comprising up to 20 wt. % of polyvalent metal ions in the form of inorganic salts, oxides or organic salts.

9. The adhesive according to claim 1 comprising a crosslinking agents selected from the group consisting of peroxides, redox systems, epoxides, sulfur compounds, amines, isocyanates and polyvalent ions.

10. The adhesive according to claim 1 in the form of a paste, a film, a thin layer, a dispersion, a solution or a latex.

11. A method of bonding a metal to substrates including applying the adhesive according to claim 1 to a surface of the metal and/or the substrates and contacting the surfaces of the metal and the substrates, wherein the substrates are selected from the group consisting of metal, glass, rubber, thermoplastic, wood, ceramic, leather, stone, concrete, plastic, fibres and textile fabrics made of natural, synthetic, glass/mineral and metal fibres.

12. A method of bonding rubber to substrates including applying the adhesive according to claim 1 to a surface of the rubber and/or the substrates and contacting the surfaces of the rubber and the substrates, wherein the substrates are selected from the group consisting of glass, rubber, thermoplastic, wood, ceramic, leather, stone, concrete, plastic, fibres and textile fabrics made of natural, synthetic, glass/mineral and metal fibres.

13. A method of bonding materials including applying the adhesive according to claim 1 to a surface of one or more materials and contacting the surfaces of the materials, wherein the materials are selected from the group consisting of metal, glass, rubber, thermoplastic, wood, ceramic, leather, stone, concrete, plastic, fibres and textile fabrics made of natural, synthetic, glass/mineral and metal fibres, in any desired combination.

14. Composite products comprising two or more materials joined with adhesives according to claim 1.

15. A process for preparing the adhesive according to claim 1, comprising mixing the constituents of the formulation in conventional mixers.

16. The process according to claim 15, wherein the mixers are mixing mills, or rubber masticators.

17. The process according to claim 15, wherein the adhesive is in solution, dispersion, suspension, oremulsion.
